(19) United States
(12) Patent Application Publication
(10) Pub. No.: US 2003/0002566 A1
(43) Pub. Date: Jan. 2, 2003

(54) System and method for shifting the phase of pseudorandom noise code in direct sequence spread spectrum communications

(76) Inventors: John G. McDonough, La Jolla, CA (US); Juncheng C. Liu, San Diego, CA (US)

Correspondence Address: TEXAS INSTRUMENTS INCORPORATED, P O BOX 655474, M/S 3999, DALLAS, TX, 75265

(21) Appl. No.: 09/884,585

(22) Filed: Jun. 19, 2001

(51) Int. Cl. H04K 1/00

(52) U.S. Cl. 375/147

(57) ABSTRACT

A system and method for shifting the phase of a PN code sequence are provided, useful in communications networks where power can be conserved by powering-off the PN clock and PN generators during slotted mode sleep intervals. The system and method targets a family of time intervals, and stores phase shifting masks corresponding to these probable intervals. The PN code generated with the phase-shifting mask at power-up is sufficiently accurate to permit rapid resynchronization. Further, because the phase-shifting masks do not have to be calculated, processing time is minimized and the PN clock and generators can be powered-off for longer periods of time.

### BACKGROUND OF THE INVENTION

1. Field of the Invention

This invention relates generally to the field of direct sequence spread spectrum (DSSS) communications and, more particularly, with a system and method of phase shifting pseudorandom noise (PN) code for more efficient power conservation during slotted mode sleep intervals.

2. Description of the Related Art

The following description of the related art comes primarily from the “Background of the Invention” Section of U.S. Pat. No. 5,491,718. The pan-European digital cellular radio system which is in use in Europe (Groupe Speciale Mobile or GSM) implements a discontinuous reception (DRX), or “slotted paging mode”, when operating in an idle mode. In this mode a radiotelephone, also referred to herein as a mobile station, does not continuously monitor a paging channel when in the idle mode. Instead, the mobile station is required to monitor the paging channel only during an assigned paging channel time slot. During all other paging channel time slots the mobile station can place itself into a low power mode of operation, such as by removing power from selected circuitry, thereby reducing power consumption and prolonging battery life.

A convenient method to make power consumption comparisons for the DRX mode employs the duty cycle of receiver on to off (sleep) time. The lower the duty cycle, the less time the mobile station is required to be powered on. A reduction in the on time, or conversely an increase in the off or sleep time, provides a reduction in power consumption and an increase in battery life.

In GSM, the idle mode is based on the concept of multiframes, each of which is 235 milliseconds (ms) long. The mobile station is required to read one paging message every two to nine multiframes (470 ms to 2.1 seconds), as specified by the base station. In addition, each paging message consists of four frames, where a frame is 4.614 ms in duration. A mobile station is only required to receive one timeslot per frame. Therefore, the mobile station is required to receive only one paging message, of 18.46 ms (4×4.615 ms) duration, every 470 ms to 2.1 seconds. Of this 18.46 ms, the receiver circuitry is on for the minimum time, the duty cycle ranges from a maximum of 2.31 ms/470 ms=3.9% to a minimum of 18.46 ms/2.1 seconds=0.9%.

As originally proposed for the US Code Division Multiple Access (CDMA) system, the mobile station must periodically receive at least one 20 ms frame within a slot cycle, as determined by a SLOT_CYCLE_INDEX value. The index is selected by the mobile station, except that the base station can set the maximum index to correspond to approximately one second cycle time (e.g., IS-95 uses 1.28 second). A typical, reasonable slot cycle for a mobile station is approximately 2.56 seconds. In addition, there exists a certain amount of overhead to receive a slotted page message. Based the above information, the duty cycle values are significantly greater than the minimum and maximum values achievable with the GSM system.

Because of continuous convolutional coding on the CDMA paging channel, the mobile station must receive at least a frame before the 20 ms frame, depending on the paging channel data rate. This time, in conjunction with various turn-on times in the mobile station receiver, results in a typical overhead of up to 100 ms. The total on-time of the mobile station thus becomes approximately 120 ms, resulting in a duty cycle between 20% and 30%, depending on the slot cycle length.

Furthermore, it is possible that the mobile station would be required to receive two paging channel slots. This can occur if the base station uses the MORE_PAGES bit in the SLOTTED PAGE MESSAGE, thereby requiring the mobile station to receive up to one additional slot. Also, the CDMA specification states that the mobile station may stop listening to the paging channel after reading the SLOTTED PAGE MESSAGE. There is no guarantee that this message is located at the beginning of the slot. As a result, it may happen that the mobile station must always listen to the entire slot.

As presently specified for use, a CDMA mobile station includes a system time PN generator, also referred to herein as a “short code” as opposed to “long code” generator. The system time short code PN generator has a rollover period of 26.67 milliseconds, and is aligned with the frame timing (20 milliseconds) every 80 milliseconds.

Another feature of the CDMA system is the use of a Long Code for mobile unit identification. The Long Code is a PN sequence with period 2⁴²−1 that is used for scrambling on the Forward (base station to mobile) CDMA Channel and for spreading on the Reverse (mobile to base station) CDMA Channel. The Long Code uniquely identifies a mobile station on both the Forward and Reverse Traffic Channels. The Long Code also serves to provide limited privacy, and separates multiple Access Channels on the same CDMA channel. A Long Code Mask is a 42 bit binary number that creates the unique identity of the Long Code.

A problem is created when it is desired to periodically shutoff a long code generator, such as when powering down the mobile station when operating in the slotted paging (DRX) mode described above, and to then restart the long code generator in the proper state when powering back up. Since the long code generator is intended to run continuously, it is essential that the long code generator be initialized to the proper state whenever it is started after a period of non-operation.

One method has been proposed which would read the state of the long code generator just prior to powering down the mobile station. A complex matrix multiply operation is then applied to the long code to determine the correct state of the long code generator at a time in the future when the long code generator is to be reinitialized.

However, this approach is computationally expensive. As a result, it may be necessary to “WAKE UP” the mobile station earlier than would be necessary if the complex matrix multiply operation is performed after the power down period. If the matrix multiply is performed before powering down, then the mobile station must remain in a powered up state for a period of time sufficient to accomplish the matrix multiply. In either case, the mobile station is powered on for a longer time. This causes the overall duty cycle and power consumption to increase, thus decreasing battery life.

As noted in the Background Section of U.S. Pat. No. 5,228,054, Pseudo-noise or pseudorandom noise generators are commonly used for bandwidth spreading of a digital signal in a direct sequence spread spectrum communication system. In such systems, such as CDMA systems, the PN sequence is commonly generated by a Linear Sequence Shift Register (LSSR).

The LSSR is comprised of an N-stage shift register, with some intervening exclusive-OR gates to program a specific PN sequence. The location of the exclusive-OR gates is determined by the defining polynomial of the circuit which in turn, determines which one of the possible sequences will be generated. There are a total of 2^{(N-1)}−1 polynomials for a generator of length N. Only a fraction, about 10%, produce a “maximal” length sequence. A “maximal” length sequence is of length (2^{N}−1).

For example, a generator with 15 stages and a maximal polynomial will produce a sequence that is 32,767 bits (or “chips”) long. In this example, the sequence will contain a single run of 15 ones in a row, and a single run of 14 zeroes in a row. All other runs of ones and zeroes are shorter in length. Every maximal length sequence generator with N stages produces a single run of N ones in a row and a single run of N−1 zeroes in a row.

In many practical applications of PN sequence generators, a sequence length of 2^{N}−1 is inconvenient because these numbers contain few factors and are frequently prime numbers. This makes it difficult to synchronize a system which contains processes operating at a lower rate than the PN chip rate.

In a practical example, a PN sequence rate of 1.2288 MHz is desired along with a data modulation rate of 9600 bits per second. The information bits are exclusive-ORed with the PN sequence and the result is biphase modulated onto an RF carrier for transmission. This provides 128 PN “chips” per information bit. In another mode of operation, the PN rate would remain the same but the data rate would be reduced to 4800 bits per second or 256 PN “chips” per information bit. It would be desirable to synchronize the data modulation to the PN sequence repetition. However, if the sequence is of length 32767, i.e. 2¹⁵−1, which has only the factors 7, 31 and 151, then the repetition interval o the PN code and the above two data rates will only coincide every 128 or 256 repetition intervals of the PN sequence. This coincidence occurs only every 3.4 or 6.8 seconds, respectively

However, pseudonoise signal generators (PNSGs) are not limited to LFSRs. An PNSG is typically composed of a series of N stages, each stage including a memory element or memory step, depending on whether the PNSG is implemented in hardware or software, whose inputs are linear combination (modulo 2) of the output memory element or step and previous memory element or step when viewed from a left-to-right perspective. The individual ones and zeroes (“bits”) of the output sequence of a PNSG, i.e., of a PN code, are sometimes referred to as “chips”.

FIG. 1 is a schematic block diagram illustrating a specific example of an PNSG 1 for N=4 (prior art). The PNSG 1 may be implemented in hardware, in which case FIG. 1 represents an LFSR, or it may be implemented in software, in which case FIG. 1 represents a structure for the logical flow of the method so implemented. Discussion below assumes software implementation.

In FIG. 1 can be seen the four memory steps 50, 52, 54, 56, as well as an adder 58 disposed between memory steps 54 and 56. The output of memory step 50 is provided to the input of memory step 52, the output of memory step 52 is provided to the input of memory step 54, while the output of memory step 54 is provided to one input of adder 58. The output of adder 58 is provided to the input of memory step 56, with the output of the PNSG being the output 60 of memory step 56. A feedback path 60 is also provided from the output 60 of memory step 56 to the input of memory step 50 and to the other input of adder 58.

The operation of the PNSG 1 shown in FIG. 1 can be described by either a state diagram or a table. The “state” of the PNSG 1 is the value of the bits stored in the memory steps at a specific time before, or after, a given iteration. Thus, for PNSG 1, the state at time “n” may be expressed as Sₙ=s₁s₂s₃s₄, where s₁, s₂, s₃, and s₄ are the values of the bits stored in memory steps 50, 52, 54, 56, respectively. If the memory steps 50, 52, 54, 56, of PNSG 1 are initialized, at time tₒ, with the state Sₒ=0001, the output and subsequent states of the PNSG are shown in Table 1.

TABLE 1

| Clock Cycle | | |
|---|---|---|
| or Iteration | State | Output |
| 0 | 0001 | 1 |
| 1 | 1001 | 1 |
| 2 | 1101 | 1 |
| 3 | 1111 | 1 |
| 4 | 1110 | 0 |
| 5 | 0111 | 1 |
| 6 | 1010 | 0 |
| 7 | 0101 | 1 |
| 8 | 1011 | 1 |
| 9 | 1100 | 0 |
| 10 | 0110 | 0 |
| 11 | 0011 | 1 |
| 12 | 1000 | 0 |
| 13 | 0100 | 0 |
| 14 | 0010 | 0 |
| 15 | 0001 | 1 |

With respect to Table 1, note that after the 15th iteration the state of the PNSG reaches that of the initial or 0th iteration. In fact, the output and state sequences of the PNSG repeat with a period of 15. For the case of n=4, this represents the maximum possible period since the all zeroes state never occurs. Thus, in general, a PNSG is capable of generating a sequence of period (or, length) 2^{N}−1, where N is the number

Not all PNSG configurations generate a sequence with the largest possible period, but those that do are said to generate a maximal length sequence or m-sequence for short. For the purposes of the present invention, PNSGs that generate m-sequences are of primary interest and hence discussion herein focuses on PNSGs having this property.

In CDMA applications it is sometimes necessary to determine the state of a PN code generator such that, when such state is loaded, the output sequence will begin at some desired point in the sequence. For example, if the PNSG of FIG. 1 is initialized with S₀=1010 instead of S₀=0001, the state and output sequences are shown in Table 2.

TABLE 2

| Clock Cycle | | |
|---|---|---|
| or Iteration | State | Output |
| 0 | 1010 | 0 |
| 1 | 0101 | 1 |
| 2 | 1011 | 1 |
| 3 | 1100 | 0 |
| 4 | 0110 | 0 |
| 5 | 0011 | 1 |
| 6 | 1000 | 0 |
| 7 | 0100 | 0 |
| 8 | 0010 | 0 |
| 9 | 0001 | 1 |
| 10 | 1001 | 1 |
| 11 | 1101 | 1 |
| 12 | 1111 | 1 |
| 13 | 1110 | 0 |
| 14 | 0111 | 1 |
| 15 | 1010 | 0 |

A related problem in the area of CDMA is as follows. Supposed the state S₁ of an PNSG is known at some particular time t₁. Assume that the clock to the PNSG is inhibited for K cycles. It is desired to know what the PNSG state, S₂, would be at time t₂=t₁+KT, where T is the clock period, had the operation of the PNSG not been inhibited. This situation occurs when a CDMA receiver is disabled for a known period of time, namely K clock cycles, to conserve power and thus extend battery life. It is necessary to quickly return the PNSG to the state it would have reached to avoid a time-consuming reacquisition and reinitialization process. In practice, however, the amount of processing required to determine the state S₂ may preclude its computation in a reasonable

It would be advantageous if a pre-calculated phase-shifting mask could be used in phase shifting PN codes following a slotted mode sleep interval, to maximize to amount of time that code generator and clock circuits can be powered down.

It would be advantageous if a predetermined family of phase-shifting masks could be saved in memory to phase shift PN codes in a practical range of sleep intervals.

It would be advantageous if the phase-shifting mask could be selected from memory in response to the sleep interval.

### SUMMARY OF THE INVENTION

Accordingly, a method for shifting the phase of a PN code is provided. As used herein, a PN code can be a long or short code as used in code division multiple access (CDMA) communications, or any other PN code with a periodic sequence. The method starts with a PN code having a first phase. The method comprises: determining a first time interval; selecting a stored or pre-calculated phase-shifting mask (or multipath mask) in response to the first time interval; shifting the PN code first phase with the phase-shifting mask; and, generating a PN code with a second phase, offset the first time interval from the PN code first phase.

In the context of a DSSS receiver, the first time interval corresponds to a slotted mode interval, and a plurality of possible first time intervals exist. Likewise then, the phase-shifting mask is selected from a plurality of stored phase-shifting masks.

The DSSS receiver accepts transmissions spread using the PN code, and the transmissions are despread using the PN code. The method further comprises: generating the PN code at a first chip rate. Then, a second time interval is selected which corresponds to the programmed sleep interval. Following the selection of a second time slotted mode sleep interval, the method further comprises: powering off the first chip rate clock; and, powering on the first chip rate clock. After awakening, the method determines the first time, or actual sleep interval, as the receiver may have been awakened before the programmed schedule. The phase mask is selected in response to the actual sleep interval. Following the generating of the PN code with the second phase, the generated PN code is resynchronized with the accepted transmissions spread using the PN code.

A DSSS communications network receiver is also provided to accomplish the functions of the above-described process. Details of the receiver, and further details of the process, are provided below.

### BRIEF DESCRIPTION OF THE DRAWINGS

FIG. 1 is a schematic block diagram illustrating a specific example of an PNSG 1 for N=4 (prior art).

FIG. 2 is a schematic block diagram of a DSSS communications network receiver of the present invention.

FIG. 3 is a schematic block diagram illustrating in more detail the PN code generator of FIG. 2.

FIG. 4 is an illustration of the relationship between the time intervals and the phase shifting masks.

FIG. 5 illustrates the resolution of a group of stored phase-shifting masks.

FIG. 6 is an illustration of an alternate resolution interval in a group of stored phase-shifting masks.

FIG. 7 illustrates the present invention method for shifting the phase of a pseudorandom noise (PN) code.

### DETAILED DESCRIPTION OF THE PREFERRED EMBODIMENTS

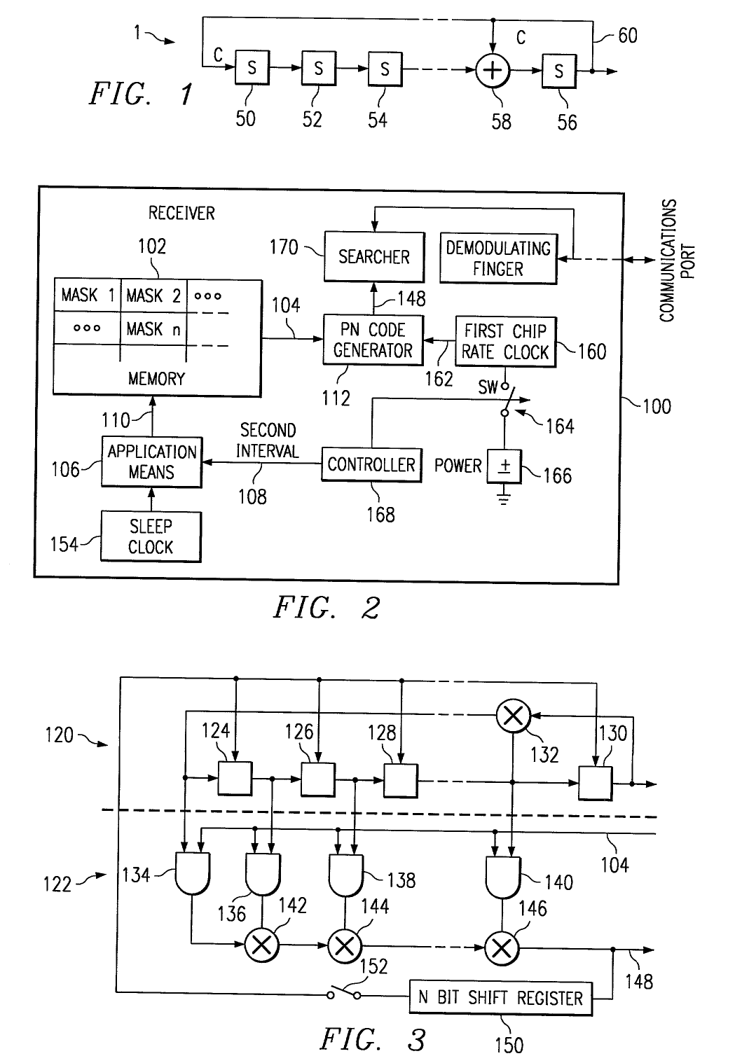

FIG. 2 is a schematic block diagram of a DSSS communications network receiver of the present invention. The receiver 100 comprises a memory 102 having a port on line 104 to supply a phase-shifting mask. An application means 106 has an input on line 108 to accept a first time interval. The application means 106 cross-references the first time interval to a phase-shifting mask, and has an output connected to the memory port on line 110 to request the phase-shifting mask. The application means 106 can be implemented in hardware. Alternately, the application means 106 is a software program of machine executable instructions stored in a memory, operated on by a microprocessor (not shown).

A pseudorandom noise (PN) code generator 112 has a first input connected to the memory 102 on line 104 to accept the phase-shifting mask. The PN code generator 112 offsets, or shifts the phase of a PN code using the phase-shifting mask. The PN code generator 112 has an output on line 148 to supply the PN code with a second phase, offset from the PN code first phase.

FIG. 3 is a schematic block diagram illustrating in more detail the PN code generator 112 of FIG. 2. The PN code generator 112 includes a sequential PN code generation section 120, which is similar to the PNSG 1 of FIG. 1, except that the XOR (exclusive-OR) logic gates are located in the feedback path, instead of between registers. The operation of the sequential PN code generation section 120 is similar to the generator described in the Background Section, above (FIG. 1). The dotted lines are intended to indicate that the PN code generator 112 is not limited to any particular number of registers or bits in the PN code state. The sequential PN code generation section 120 generates the PN code at a first chip rate. In addition, the PN code generator 112 includes a phase-shifting section 122. The PN code loaded in registers 124 through 130 can be considered the PN code first phase, and the PN states are generated with the aid of XOR gate 132. The phase-shifting mask is received on line 104. Note that in FIG. 3, the PN code generator 120 shows four stages (N=4) for simplicity. More practically, N might equal 42 to generate long code or 15 to generate shot code for IS-95A, TIA/EIA-95-B, or IS-2000 communications. However, the invention is not limited to any particular value of N.

A logical AND operation is performed between the phase-shifting mask and the PN code first phase. That is, elements 134 through 140 operate as AND gates. The bits in registers 124 through 130 are respectively ANDed with the bits in registers 134 through 140. The outputs are sequentially XOred using XOR gates 142 through 146. The results of the combining process are output on line 148 and stored in shift registers 150. The PN code state in registers 150 can be considered the PN code second phase. The PN code second phase can be loaded into registers 124 through 130 of the sequential PN code generation section 120 as a starting point for sequential state generation or as the starting process of a new PN code phase shift state. Switch 152 is intended to represent the parallel shift operation of a complete word, after a complete word is generated. That is, if generator 120 is a 42 bit generator, shift register 150 will collect 42 bits before they are loaded into registers 124 through 130. As explained below, some phase shift processes require the use of more than one phase-shifting mask, and more than one phase shift process.

Alternately, the PN generator 1 of FIG. 1 can be used in combination with the generator 120 of FIG. 3. The generator 1 can be used in the normal, bit-by-bit sequential operation at the first bit rate. When an incremental phase shift is to be performed, the PN code first phase can be converted into a format with the equivalent phase for operation with the PN generator 120 of FIG. 3. After the PN code second phase is generated, it is converted into a format equivalent phase for operation with the PN generator 1 of FIG. 1, and the normal bit-by-bit incremental shift process can be resumed.

Returning to FIG. 2, the memory 102 includes a plurality of phase-shifting masks in storage. As described below, the application means 106 cross-references a plurality of time intervals to the plurality of phase-shifting masks in memory 102.

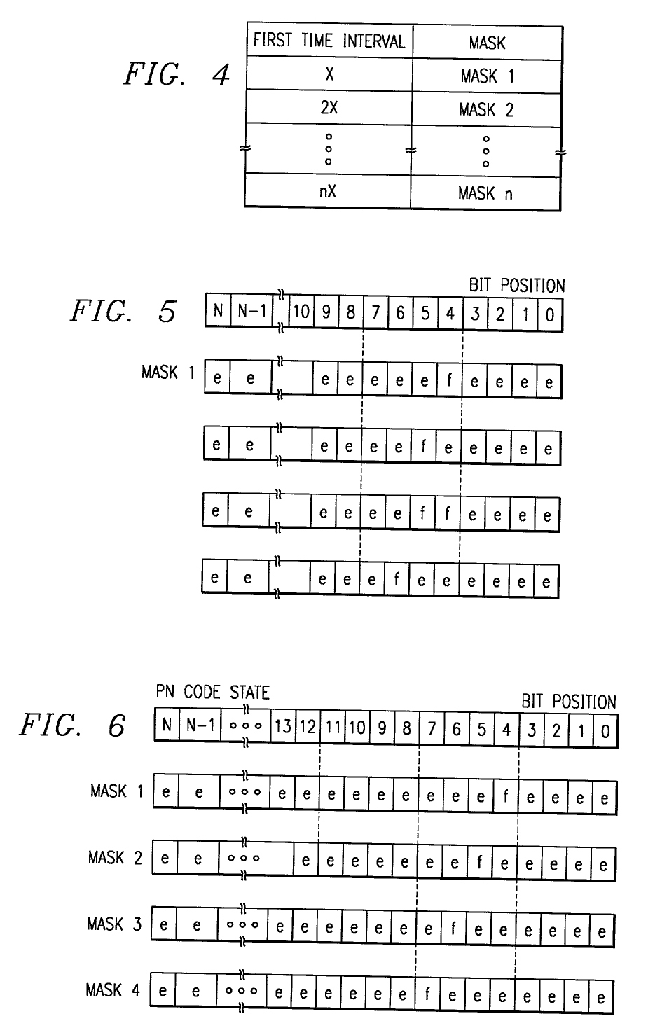

FIG. 4 is an illustration of the relationship between the time intervals and the phase shifting masks. Returning to FIG. 2, the application means 106 determines a first time interval. In the context of CDMA communications, the first time interval is the actual sleep interval, or the amount of time the PN generator was actually shut off. As explained below, the spacing between time intervals may be insufficient to perfectly resolve the actual sleep interval. Typically, the application means accepts a second time interval which represents the intended sleep interval. However, the receiver 100 may be awaken earlier, or perhaps later than intended. In some aspects of the invention, a separate mask is stored corresponding to each increment in the range of first time intervals, as shown in FIG. 4. Alternately, fewer masks are stored, for example, one mask for each doubling of the second time interval. Then, the first time interval is obtained by using a combination of masks.

Both the first and second time intervals are proportionally related to the first chip rate. It should be understood, however, that calibration errors and low resolution timing mechanisms may prevent a perfect correlation between the first chip rate and interval timing. In some aspect of the invention, the plurality of first time intervals have a resolution of x, where x is equal the first chip rate. In alternate aspects of the invention, the plurality of first time intervals have a resolution of q times the first chip rate, where q is an integer. In this aspects of the invention, it may be impossible to exactly match the first time interval to the actual sleep interval, and the assumption is made that the error can be compensated for in other mechanisms, such as a searcher. The advantage of a low resolution interval is a fewer number of phase-shifting masks in storage. Returning to FIG. 2, in some aspects of the invention, a sleep clock 154 provides the low resolution clock period, proportionally related to the first chip rate, to the application means 106.

FIG. 5 illustrates the resolution of a group of stored phase-shifting masks. The sequential PN code generation section (120, see FIG. 2) generates the PN code with (2^{N}−1) states, and a period m equal to (2^{N}−1) times the first chip rate. Alternately stated, each PN code state, or phase-shifting mask includes N bits, and a total of (2^{N}−1) masks can be formed. The first time interval is selected in the range between zero and m, with a resolution of x. Generating a PN code with a second phase, offset a second time interval from the PN code first phase includes generating a PN code with a second phase that is offset with respect to time in units of x.

In some aspects of the invention, the period m may be a long period of time, much longer than any possible slotted mode sleep interval of interest. Therefore, it may be sufficient to generate a limited number of masks where the most significant bit of interest is not in the N bit place. That is, only phase-shifting masks that describe relatively short intervals of time, or relatively small phase shifts. As a result, it may be unnecessary to generate the phase-shifting masks where the higher order bits are of interest. Likewise, the lower order bits of the phase-shifting masks may represent times that are insignificantly small compared to calibration errors. Therefore, fewer than (2^{N}−1) masks are typically needed to describe a practical range of time intervals, even when the resolution of the time interval is in units of the first chip rate.

In some aspects of the invention, it is not necessary to use lower-order bit (small time interval) masks. As shown, mask 1 consists of “e” bits in bit positions 0, 1, 2, and 3. The “e” is intended to represent a “0” bit spread by the PN code. The “f” bit in the bit position 4 is intended to represent a “1” bit spread by the PN code. In this example mask 1 represents the smallest time interval x of interest. It is assumed that bits positions 0 through 3 are insignificant. For example, these bits may represent a synchronization error that is easily resolved.

Mask 2 is the phase-shifting mask corresponding to the next significant time interval 2x, larger than the time interval corresponding to mask 1. Mask 3 corresponds to the next time interval 3x and mask four the next 4x. This relationship continues out to mask n, which corresponds to time interval nx. Thus, there is a mask for every time interval, and a minimal amount of processing time is required to calculate the PN code second phase.

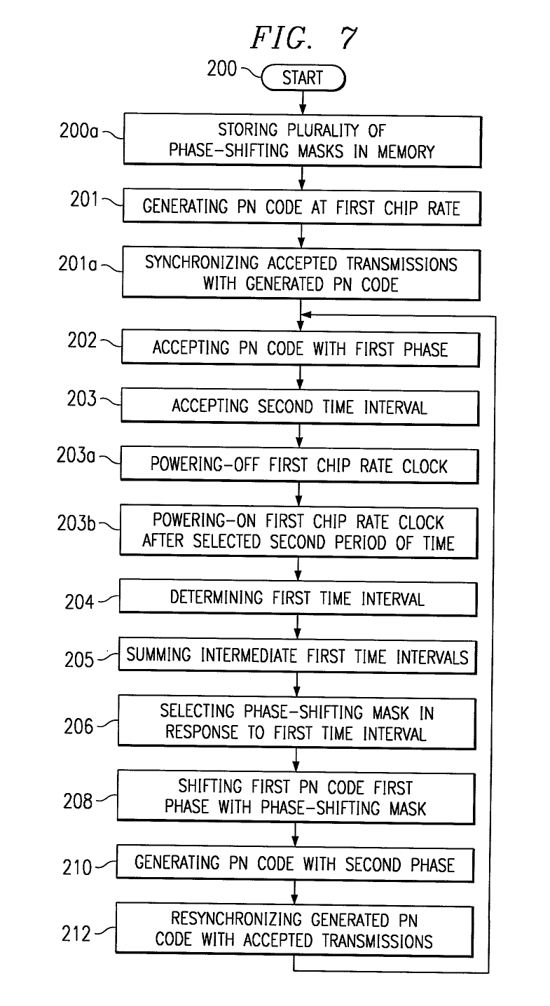

FIG. 6 is an illustration of an alternate resolution interval in a group of stored phase-shifting masks. The present invention is not limited to any particular value. In one aspect of the invention a more limited number of masks are required in storage. The ability of the receiver 100 to use a mask from memory, instead of calculating one, saves processing time. However, by storing a limited number of masks, the penalty in memory use is minimized.

If the interval between stored masks is different than the resolution of the time interval, then the PN code first phase must be shifted with a plurality of masks. Shifting the PN code first phase includes iteratively shifting the PN code first phase with each of the plurality of selected phase-shifting masks, forming intermediate PN code phases until the PN code second phase is achieved.

More specifically, FIG. 6 shows that, beginning at bit position 4, a mask is stored for every bit position. Thus, mask 1 represents time interval x, mask 2 represents time interval 2x, mask 3 represents time interval 4x, and mask 4 represents time interval 8x. Thus, a mask is stored for every bit position of interest. When none of the plurality of first intervals match the actual sleep interval, the actual sleep interval can be obtained by summing. Thus, the actual sleep interval is obtained by summing a plurality of the phase-shifting masks in storage. More specifically, when there are log₂ (n) time intervals between x and nx, then log₂ (n) masks are stored.

The mask sets depicted in FIGS. 5 and 6 represent the opposite ends of the practical extremes in mask storage. In FIG. 5, a mask is stored for every incremental time interval in the range of time intervals between x and nx. Only one mask operation is required, so the processing time is minimal. In FIG. 6, a much smaller number of masks are stored, however, several masks, and therefore several mask operations, may be required to obtain the desired time interval. For example, if the time interval to be resolved corresponds to 3x, and only masks corresponding the time intervals of x, 2x, 4x, . . . are stored, then two masks must be used. That is, the x and the 2x masks. Therefore, the PN code first phase is shifted with a first operation using mask 1 and a second operation using mask 2 (the order does not matter). Worst case, a time interval could be selected that would require log₂ (n) mask operations.

Alternately, a compromise can be enacted between the extremes represented by FIGS. 5 and 6. Then, the group of masks in storage would be greater than the number represented in FIG. 6, but less than the number represented in FIG. 5. As a result, processing time (the number of likely mask operations) would be reduced at the expense of mask storage. In one aspect of the invention, masks are stored which correspond to time intervals that the system is likely to require, or to an often used time interval, or the last used time interval.

Returning to FIG. 2, the receiver 100 receives transmissions that are spread with the PN code. Note, that the transmissions can be spread with both long and short codes, and present invention describes a mechanism for shifting phase with either of these code types. The receiver 100 further comprises a first 160 having an output on line 162 connected to the PN code generator 112. The first chip rate clock 160 is powered-off at the beginning of the first time period, and powered-on again at the finish of the first time period. The first chip rate clock, and other circuitry not shown, is shut to conserve power during the sleep mode interval. A switch 164 represents the disconnection of the first chip rate clock 160 from the power source 166. A controller 168, including a low power sleep mode clock, supplies commands to operate the switch 164 and supplies the first time interval to the application means on line 108.

Also shown is a searcher section 170 having an input connected to PN code generator output on line 148 to accept the PN code with the second phase shift. The searcher section 170 resynchronizes the accepted transmissions with the generated PN code, following the power-on of the first chip rate clock 160. As can be appreciated by those skilled in the art, the time required for resynchronization is approximately proportional to the error between the PN code second phase and the phase of the PN code used to spread the transmissions.

There are many advantages of being able to adjust the code sequence from any state to any other state. For example, constraints are reduced on when modems can go to sleep or when they can wake up. The time it takes to adjust the long code state is proportional to log (slot interval), which is very small and relatively constant for typical slot cycles used in mobile telephone network. For example, assuming LFSR state advances at a rate of 1,228,800 states per second, Table 3 shows the maximum adjustment time versus number of required 42-bit mask operations using masks which process the adjustment 4 bits at a time. With six 42-bit mask operations, slot cycles at 1.28 s, 2.56 s, 5.12 s, 10.24 s and 20.48 s are covered. The reduction in cycle adjustment time permits tighter control of the wake up time and maximizes the power savings. In addition, it can also be used in situations where long code state adjustment is desired. For example, during the initial timing acquisition, a DSSS mobile telephone system is required to synchronize to a mobile telephone network system time with a given long code state valid at some time in the future. By advancing the long code states with an adjustment amount compatible to the modem design, a faster acquisition becomes possible. Note that although 4 bits are used in this example, it could will be set for 3, 5 or any other number of bits. With the trade-off of number of masks needed for storage with the number of masks required for processing being left for the particular system requirments.

TABLE 3

| | | | | | | |
|---|---|---|---|---|---|---|
| [Maximum | 1.707 | sec | 27.307 | sec | 436.9 | sec |
| achievable] | | | | | | |
| adjustment time | | | | | | |
| Number of required | 5 | | 6 | | 7 | |
| 42-bit mask | | | | | | |
| operations | | | | | | |

FIG. 7 illustrates the present invention method for shifting the phase of a pseudorandom noise (PN) code. Although the method is presented as a sequence of numbered steps for clarity, no order should be inferred from the numbering unless explicitly stated. The method of FIG. 7 includes aspects of the invention which are enabled through a combination of software applications of machine executable instructions stored in memory and a microprocessor, or combinations or hardware and software applications.

The method begins at Step 200. Step 202 accepts a PN code with a first phase. Step 204 accepts a first time interval. Step 206 selects a phase-shifting mask in response to the first time interval. Step 208 shifts the first PN code first phase with the phase-shifting mask. Step 210 generates a PN code with a second phase, offset the first time interval from the PN code first phase.

In some aspects of the invention, accepting a first time interval in Step 204 includes determining a first time interval from among a plurality of first time intervals. Likewise, selecting a phase-shifting mask in response to the first time interval in Step 206 includes selecting a phase-shifting mask from a plurality of phase-shifting masks.

In some aspects of the invention further steps are included. Step 201 generates the PN code at a first chip rate. Step 203 accepts a second time interval proportionally related to the first chip rate. Further, accepting a second time interval in Step 203 typically includes selecting a second time interval from among a plurality of second time intervals, that are also proportionally related to the first chip rate.

In some aspects of the invention, determining a first time interval from among a plurality of first time intervals in Step 204 includes selecting a first time interval from among a plurality of first time intervals that are offset from each other by predetermined periods of time. Then, selecting a phase-shifting mask from among a plurality of phase-shifting masks in Step 206 includes selecting a phase-shifting mask from among a plurality of phase-shifting masks that are offset from each other by PN code phase shifts corresponding to the plurality of first time intervals.

In some aspects of the invention, generating the PN code with the first chip rate in Step 201 includes generating a PN code with (2^{N}−1) phases, and a period m equal to (2^{N}−1) times the first chip period. Then, selecting a second time interval in Step 205 includes selecting a second time interval in the range between m and zero, with a resolution of x. The resolution x can be in units of the first chip period or q times the first chip period, where q is an integer. Generating the PN code with a second phase, offset a first time interval from the PN code first phase in Step 210 includes generating a PN code with a second phase that is offset with respect to time in units of x.

In some aspects, selecting a phase-shifting mask in response to the selected second time interval in Step 206 includes selecting a plurality of phase-shifting masks. Then, shifting the PN code first phase with a phase-shifting mask in Step 208 includes iteratively shifting the PN code first phase with each of the plurality of selected phase-shifting masks.

In some aspects of the invention, a direct sequence spread spectrum (DSSS) receiver with a memory is included. Selecting a first time interval in Step 204 includes selecting a first time interval in the range between x and nx. Then, the method includes further steps. Step 200a stores nx phase-shifting masks in memory, corresponding to the plurality of first time periods between x and nx, where each first time period has a resolution of x. Then, selecting a phase-shifting mask in Step 206 includes selecting a phase-shifting mask from the nx phase-shifting masks stored in memory.

Alternately, Step 200a stores log₂ (n) phase-shifting masks in memory corresponding to log₂ (n) intermediate time intervals between x and nx. Step 205 sums intermediate first time intervals to form a first time interval sum. Selecting a phase-shifting mask in Step 206 includes selecting phase-shifting masks from memory corresponding to each of the intermediate time intervals in the first time interval sum. Shifting the PN code first phase with phase-shifting mask in Step 208 includes shifting the PN code first phase with the phase-shifting masks selected from memory.

In some aspects of the invention, the DSSS receiver accepts transmissions spread using the first PN code, and the DSSS receiver includes a first chip rate clock. The method comprises further steps. Step 201a synchronizes the accepted transmissions with the generated PN code. Following the accepting of a second time interval in Step 203, Step 203a powers-off the first chip rate clock during a slotted mode sleep interval. Step 203b powers-on the first chip rate clock after the selected second period of time. Following the generating of the PN code with the second phase in Step 210, Step 212 resynchronizes the generated PN code with the accepted transmissions.

A system and method for shifting the phase of a PN code sequence have been presented above. The system and method target a family of highly probable time intervals, and stores phase-shifting masks corresponding to these probable intervals. A few examples of such a process have been given for illustration, but other embodiments and variations will undoubtedly occur to those skilled in the art.

We claim

What is claimed is:

1. A method for shifting the phase of a pseudorandom noise (PN) code, the method comprising:
accepting a PN code with a first phase;
determining a first time interval;
selecting a phase-shifting mask in response to the first time interval;
shifting the PN code first phase with the phase-shifting mask; and
generating a PN code with a second phase, offset by the first time interval from the PN code first phase.

2. The method of claim 1 wherein determining a first time interval includes accepting a first time interval from among a plurality of first time intervals.

3. The method of claim 2 wherein selecting a phase-shifting mask in response to the first time interval includes selecting a phase-shifting mask from a plurality of phase-shifting masks.

4. The method of claim 3 further comprising:
generating the PN code at a first chip period;
accepting a second interval proportionally related to the first chip period.

5. The method of claim 4 wherein accepting a second time interval includes accepting a second time interval from among a plurality of second time intervals.

6. The method of claim 5 wherein determining a first time interval from among a plurality of first time intervals includes determining a first time interval from among a plurality of first time intervals that are offset from each other by predetermined periods of time; and
wherein selecting a phase-shifting mask from among a plurality of phase-shifting masks includes the sub-step of selecting a phase-shifting mask from among a plurality of phase-shifting masks that are offset from each other by PN code phase shifts each one corresponding to one of said first time intervals.

7. The method of claim 6 wherein generating the PN code with the first chip period includes generating a PN code with (2^{N}−1) states, and a period m equal to (2^{N}−1) times the first chip period;
wherein determining a first time interval includes selecting a first time interval in the range between zero and m, with a resolution of x; and
wherein generating a PN code with a second phase, offset a second time interval from the PN code first phase includes generating a PN code with a second phase that is offset with respect to time in units of x.

8. The method of claim 7 wherein x is the first chip period.

9. The method of claim 7 wherein x is equal to the first chip period times q, where q is an integer.

10. The method of claim 7 wherein selecting a phase-shifting mask in response to the first time interval includes selecting a plurality of phase-shifting masks; and
wherein shifting the PN code first phase with a phase-shifting mask includes iteratively shifting the PN code first phase with each phase-shifting mask from the plurality of selected phase-shifting masks.

11. The method of claim 7 in which a direct sequence spread spectrum (DSSS) receiver with a memory is included, wherein determining a first time interval includes determining a first time interval in the range between x and nx; and
and the method further comprising:
storing n phase-shifting masks in memory, corresponding to the plurality of first time periods between x and nx; and
wherein selecting a phase-shifting mask includes selecting a phase-shifting mask from the n phase-shifting masks stored in memory.

12. The method of claim 7 in which a direct sequence spread spectrum (DSSS) receiver with a memory is included, wherein determining a first time interval includes determining a first time interval from a plurality of first time intervals in the range between x and nx; and
and the method further comprising:
storing log₂ (n) phase-shifting masks in memory corresponding to log₂ (n) intermediate time intervals between x and nx;
summing intermediate first time intervals to form a first time interval sum;
wherein selecting a phase-shifting mask includes selecting phase-shifting masks from memory corresponding to each of the intermediate time intervals in the first time interval sum; and
wherein shifting the PN code first phase with phase-shifting mask includes shifting the PN code first phase with the phase-shifting masks selected from memory.

13. The method of claim 7, wherein the number of masks used for storage and the number of masks required for processing being adjustable.

14. The method of claim 7 in which the DSSS receiver accepts transmissions spread using the first PN code, and in which the DSSS receiver includes a first chip rate clock;
the method further comprising:
synchronizing the accepted transmissions with the generated PN code;
following the selecting of a second time interval, powering-off the first chip rate clock during a slotted mode sleep interval;
powering-on the first chip rate clock; and
wherein determining the first time interval includes determining the sleep time interval that the first rate clock was powered-off; and
the method further comprising:
following the generating of the PN code with the second phase, resynchronizing the generated PN code with the accepted transmissions.

15. In a direct sequence spread spectrum (DSSS) communications network, a receiver comprising:
a memory having a port to supply a phase-shifting mask;
an application means to determine a first time interval, the application means cross-referencing the first time interval to the phase-shifting mask, the application means having an output connected to the memory port to request the phase-shifting mask; and
a pseudorandom noise (PN) code generator having a first input connected to the memory to accept the phase-shifting mask, the PN code generator offsetting a PN code with the phase-shifting mask, the PN code generator having an output to supply the PN code with a second phase, offset from the PN code first phase.

16. The receiver of claim 15 wherein the memory includes a plurality of phase-shifting masks; and
wherein the application means cross-references a plurality of time intervals to the plurality of phase-shifting masks in memory.

17. The receiver of claim 16 wherein the PN code generator generates the PN code at a first chip period;
wherein the application means determines a first time interval proportionally related to the first chip period; and
wherein the memory supplies a phase-shifting mask that is offset by a PN code phase shift proportionally related to the first time interval.

18. The receiver of claim 17 wherein the PN code generator generates the PN code with (2^{N}−1) states, and a period m equal to (2^{N}−1) times the first chip period;
wherein the application means determines a first time interval from among a plurality of time intervals in the range between zero and m, with a resolution of x; and
wherein the PN code generator generates a PN code with a second phase, offset from the PN code first phase with a phase shift, expressed as time in units of x.

19. The receiver of claim 18 wherein x is equal to the first chip period.

20. The receiver of claim 18 further comprising:
a sleep clock having an output connected to the application means with a period of q times the first chip period, where q is an integer; and
wherein the application means plurality of time intervals have a resolution of x equal to the sleep clock period.

21. The receiver of claim 18 wherein the application means includes a plurality of first time intervals in the range between x and nx; and
the memory includes n phase shift masks corresponding to the plurality of first time periods between x and nx.

22. The receiver of claim 18 wherein the application means includes a plurality of time intervals in the range between x and nx;
wherein the application means selects a plurality of log₂ (n) time intervals to form a first interval sum;
wherein the memory includes log₂ (n) phase-shifting masks corresponding to log₂ (nx) intermediate time intervals between x and nx; and
wherein the application means selects a plurality of phase-shifting masks from memory corresponding to a plurality of time intervals in the first time interval sum;
wherein the memory supplies the selected phase-shifting masks to the PN code generator; and
wherein the PN code generator iteratively shifts the PN code first phase with each of the plurality of selected phase-shifting masks to supply the PN code second phase.

23. The receiver of claim 18 in which transmissions are accepted spread with the PN code, and the receiver further comprising:
a first chip rate clock having an output connected to the PN code generator, the first chip rate clock being powered-off at the beginning of the first time period, and being powered-on at the finish of the first time period; and
a searcher section having an input connected to PN code generator output to accept the PN code with the second phase shift, the searcher section resynchronizing the accepted transmissions with the generated PN code, following the power-on of the first chip rate clock.

24. The receiver of claim 23 wherein the application means accepts a second time interval corresponding to a slotted sleep mode interval, wherein the application means programs the PN code generator to be powered off for the second time interval; and
wherein the application means determines the first time interval in response the actual time that the PN code generator was powered-off.

25. In a direct sequence spread spectrum (DSSS) communications network where transmissions are spread with a PN code, a method for conserving power in a slotted mode of operation, the method comprising:
storing a plurality of phase-shifting masks;
generating a synchronized pseudorandom noise (PN) code to despread transmissions;
accepting a slotted mode sleep second time interval from a plurality of second time intervals;
beginning the sleep mode at a first phase of the PN code;
ending the sleep interval;
determining the first time interval between the beginning and the end of the sleep interval;
selecting a phase-shifting mask from storage in response to the first time interval;
offsetting the PN code first phase with the phase-shifting mask;
generating the PN code with a second phase; and
resynchronizing the generated PN code to despread transmissions.
